(19) United States
(12) Patent Application Publication
(10) Pub. No.: US 2014/0263011 A1
(43) Pub. Date: Sep. 18, 2014

(54) NOVEL CHROMATOGRAPHIC MEDIA BASED ON ALLYLAMINE AND ITS DERIVATIVE FOR PROTEIN PURIFICATION

(71) Applicants: Bhaktavachalam Thiyagarajan, Bethlehem, PA (US); Wei Guo, Bethlehem, PA (US); Nandu Deorkar, Cedar Knolls, NJ (US)

(72) Inventors: Bhaktavachalam Thiyagarajan, Bethlehem, PA (US); Wei Guo, Bethlehem, PA (US); Nandu Deorkar, Cedar Knolls, NJ (US)

(73) Assignee: Avantor Performance Materials, Inc., Center Valley, PA (US)

(21) Appl. No.: 14/115,238

(22) PCT Filed: May 3, 2012
(86) PCT No.: PCT/US12/36237

§ 371 Date: Apr. 16, 2014

Related U.S. Application Data
(60) Provisional application No. 61/518,258, filed on May 3, 2011.

(51) Int. Cl. B01D 15/20

(52) U.S. Cl. CPC B01D 15/206
USPC 210/198.2; 521/32

(57) ABSTRACT

Chromatographic media of porous media particles derivatized with allylamine or polyallylamine obtained directly or through intermolecular polymerization on the surface thereof and such media functionalized with further functionalization groups. Such media are particularly useful for separating biomolecules.

### FIELD OF THE INVENTION

The invention relates to the preparation of a series of novel chromatographic media and use of the media for the purpose of separation and purification of biomolecules, more specifically for the separation and purification of antibodies and other related proteins. The present invention discloses a novel chromatographic media based on allylamine and polyallylamine as the major ligand and their modification with different functional groups to prepare ion exchange, hydrophobic and other functional chromatographic media with unique separation characteristics. This invention differs from the commercially available chromatographic media due to its unique ligand structure, method of making and unique separation performance.

### BACKGROUND OF THE INVENTION

Chromatographic methods are generally the most important tools in separation and purification of biomolecules. With the fast development of upstream technology, therapeutic biomolecules now can be produced in large amounts and in high concentration. The impurity profile of a starting material for downstream processing depends on several factors such as expression system, type of growth media and titer concentration. This leads to a variety of process- and product-related impurities which must be removed by a robust purification method with minimum steps. However, there have not been concomitant increases in the downstream improvements in terms of capacity and separation efficiency. To meet these requirements, chromatographic media with high protein binding capacity and separation efficiency are being actively developed.

In general, most chromatographic media are based on silica or polymer material with certain functional ligands that provide different kinds of adsorption and separation. For example, anionic ligands such as sulfonic acid or carboxylic acids will adsorb positively charged solutes and, therefore, perform separation based on cationic exchange mechanism; and cationic ligands such as amines at appropriate pH will adsorb negatively charged solutes and, therefore, perform separation based on anion exchange mechanism. Basically, the nature of the ligands determines the separation mechanism, while the density of the ligands plays a big role in the capacity of the media. Also, the media capacity is controlled by many other factors, such as surface area and pore volume, and factors such as hydrophobicity and ligand structure determine the binding and hence separation properties. In addition, nature of spacers that join the ligand and the surface of the backbone of the media also have influence on the separation depending on the hydrophilicity or hydrophobicity of the spacers. Commercially available chromatographic media such as Macro-Prep® Ion Exchange Supports (Bio-Rad), POROS® (Applied Biosystems), Sepharose FastFlow® (GE Healthcare Life Sciences), Toyopearl® (Tosoh Bioscience), PolyPEI and PolyCSx (Avantor Performance Materials, Inc. formerly Mallinckrodt Baker, Inc.), contain different functional ion-exchange and hydrophobic groups attached to surfaces and have difference types of proprietary spacers or coatings. For an example, polyamine had been used in the chromatographic media described in U.S. Patent Publication No. 2002/0134729; and polyethyleneimine had been used in chromatographic media products described in U.S. Pat. No. 4,551,245.

In 2002/0134729, anion exchangers were prepared by modifying the polymer surface with high molecular weights polyamine, preferably polyethyleneimine, with molecular weight of at least 50,000. In U.S. Patent No. 2005/0203029, polymer surface was modified with polyethylenimine to give desired surface properties for chromatographic separations. In this process, primary and secondary amino groups were also introduced on the polymer surface. Those amino groups were further utilized to react with various chromatographic ligands to prepare different media such as strong cation exchanger, weak cation exchanger and hydrophobic media. The total nitrogen content of the modified polymer typically ranged from 4 to 7%.

In previous U.S. Patent Publication Nos. 2008/003922 and 2005/094581 polymer backbone surface was modified either with molecules containing vinyl groups or with polyethylenimine to give desired surface properties to the media for chromatographic separations. In those media, primary and secondary amino groups were also introduced on the backbone of the polymer surface. Those primary or secondary amino groups were further utilized to react with various chromatographic ligands to prepare different media such as strong cation exchanger, weak cation exchanger, and hydrophobic media.

There remains, therefore, a need for improved chromatographic media, and methods of making thereof, as well as their appropriate for use in separating biomolecules.

### SUMMARY OF THE INVENTION

The present invention provides chromatographic media and methods for preparation of novel chromatographic media by reacting epoxy group containing or haloalkyl containing solid porous media support, such as for example, epoxidized or haloalkylated polymethacrylate, with allylamine or its polyallylamine derivatives obtained directly by reacting polyallylamine having a molecular weight of 25000 or less, or by intermolecular polymerization through grafted allylamine. The resulting solid chromatographic media support with allylamine or polyallylamine on the surface of its backbone may then be further functionalized by functionalization with other suitable reagents to provide various functional ion-exchange or hydrophobic media. The allylamine derivatives include polyallylamine with or without substitutions. The porous solid media support, such as epoxy or haloalkyl group containing polymers, can be spherical polymers, particular polymethacrylate or similar polymers, with average diameter from 35 to 110 micron. Other porous solid supports with epoxy groups or haloalkyl groups suitable for use in this invention include for example epoxidized or haloalkylated polystyrenes, polyacrylates, polymethacrylates, polydivinylbenzenes, silica, chitosan, cellulose, and agarose based beads. Polymeric materials used for the chromatographic separation of proteins will preferably have certain properties, such as,

1) the pore size is sufficiently large to allow rapid diffusion of molecules as large as proteins in and out of the resin particles;

2) the resin particles are to be rigid to avoid compression and loss of flow rate under the pressure encountered in chromatographic operations; and

3) the resin should be chemically stable under all conditions encountered in the separation process.

In this invention it has been discovered that allylamine and its polyallylamine derivative having molecular weight of less than 25000, obtained directly or through intermolecular polymerization, can be used as a primary ligand, and can also be modified to use as a weak anion, weak cation and hydrophobic chromatographic media with distinct characteristics. The weak anion media produced with the allylamine or polyallylamine ligands can be used directly for proteins separation, or can be further modified to produce strong cation exchange media, strong anion exchange media or hydrophobic chromatographic media. Basically, the amino group of allylamine or polyallylamine reacts with the epoxy or halogenated groups in the polymer, which can provide weak anion exchanging if used directly. In addition, remaining amino groups can further react with different functionalizing reagents to make chromatographic media with different functionality such as cation exchange, anion exchange or hydrophobic media. Also, if allylamine is used as a reactant, the double bond provides possibilities for further modifications, such as intermolecular polymerization and further functionalization to provide new ion-exchange or hydrophobic media.

For a better understanding of the present invention, together with other and further objects and advantages, reference is made to the following detailed description, taken in conjunction with the accompanying examples, and the scope of the invention will be pointed out in the appended claims. The following detailed description is not intended to restrict the scope of the invention by the advantages set forth above.

### BRIEF DESCRIPTION OF THE DRAWINGS

FIG. 1 is a graph of the elution profile, as recorded by a UV detector, of the separation of proteins according to the procedure in Example 2 using media prepared according to Example 1;

FIG. 2 is a graph of the elution profile, as recorded by a UV detector, of the separation of proteins according to the procedure in Example 4 using media prepared according to Example 3;

FIG. 3 is a graph of the elution profile, as recorded by a UV detector, of the separation of proteins according to the procedure in Example 6 using media prepared according to Example 5;

FIG. 4 is a graph of the elution profile, as recorded by a UV detector, of the separation of proteins according to the procedure in Example 8 using media prepared according to Example 7;

FIG. 5 is a chart of the binding capacity determined in accordance with Example 9;

FIG. 6 is a chart of the binding capacity determined in accordance with Example 10;

FIG. 7 is a chart of the binding capacity determined in accordance with Example 11; and

FIG. 8 is a chart of the binding capacity determined in accordance with Example 12.

### DETAILED DESCRIPTION OF THE INVENTION

This invention concerns the preparation and use of novel chromatographic media from spherical solid porous media with epoxy or haloalkyl groups. In accordance with this invention allylamine or its polyallylamine derivatives are used for modification of the porous media and thereafter for further functionalization using different ligands having suitable functional groups. In accordance with the present invention, a strong cation exchange media can be prepared by (1) reacting allylamine with porous solid media beads containing epoxy or haloalkyl groups, and, optionally (2) reacting the so obtained allylamine modified media with further other functional groups, such as for example, maleic anhydride, and then (3) reacting the product with sodium metabisulfite (Na₂S₂O₅). The temperature and duration of the reaction can vary from 40° C. to 80° C. and from about 3 hours to about 16 hours, respectively. Other suitable functionalization reagents suitable for reaction with the allylamine or polyallylamine-derivatized media particles are, for example, acid anhydrides such as cyclic carboxylic anhydrides such as glutaric and succinic anhydrides, unsaturated carboxylic anhydrides such as maleic anhydride, sulfonation agents such as bisulfites and sodium meta-bisulfite, alkyl chlorides or anhydrides such as butyryl chloride and acetic or butyric anhydride, and alkyl chlorides containing quarternary ammonium functionality such as (3-chloro-2-hydroxypropyl)trimethylammonium chloride, and mixtures of these functionalization reagents.

In one embodiment, preparation of primary ligand is carried out by reacting polyallylamine having molecular weight of less than 25000 with solid porous particles containing epoxy or haloalkyl groups, such as for example chloromethyl, bromomethyl groups, that can react with amine functional groups. Alternatively, similar primary allylamine ligands can be prepared by reacting allylamine with solid porous particles containing epoxy or haloalkyl groups and then polymerizing the attached allylamine using typical free radical or other polymerization process through either intermolecular polymerization.

In another embodiment, preparation of primary ligand is carried out via intermolecular polymerization of allylamine by first reacting allylamine with solid porous particles containing epoxy or haloalkyl groups, such as chloromethyl, bromomethyl; or other suitable reactive moieties then polymerizing grafted allylamine with excess allylamine followed by reaction with amine to obtain various functional groups.

In another embodiment, preparation of a media with primary allylamine ligand is carried out by reacting allylamine with solid porous particles containing epoxy or haloalkyl, or other suitable reactive moieties that can react with amine to obtain various functional groups.

In yet another embodiment, preparation of other functionalities such as weak cation exchange media, strong cation exchange media, and hydrophobic media are prepared from the primary allylamine ligand using other functional ligands with suitable functionalization groups as given in the examples below.

Other aspects of the invention include the following. One aspect includes chromatographic media having porous media particles derivatized with allyamine or polyallylamine on the surface of the particles. Another aspect includes such chromatographic media wherein the porous media particles include particles selected from the group consisting of epoxidized or haloalkylated silica, chitosan, cellulose, agarose, polystyrenes, polyacrylates or polymethacrylates, and polydivinylbenzenes. A further aspect includes such chromatographic media wherein the porous media particles include epoxidized or haloalkylated polyacrylates or polymethacrylates polymers. Yet another aspect includes such chromatographic media wherein the porous media particles derivatized with allylamine or polyallylamine on the surface of the particles are further functionalized by reaction of at least one other functionalization reagent with terminal amino groups of the allylamine or polyallylamine on the surface of the polymeric resin. A still further aspect includes such chromatographic media wherein the at least one other functionalization agent is selected from the group consisting of: acid anhydrides, sulfonation agents, alkyl chlorides, and alkyl chlorides containing quaternary ammonium functionality, and mixtures thereof. An even further aspect includes such chromatographic media wherein the functionalization reagent is selected from the group consisting of cyclic carboxylic anhydrides, unsaturated carboxylic anhydrides, bisulfites, alkyl chlorides, alkyl anhydrides, alkyl chlorides containing quaternary ammonium functionality and mixtures thereof. Another aspect includes such chromatographic media wherein the at least one other functionalization reagent is selected from the group consisting of: glutaric anhydride, succinic anhydrides, maleic anhydride, sodium meta-bisulfite, butyryl chloride, acetic anhydride, butyric anhydride, (3-chloro-2-hydroxypropyl) trimethylammonium chloride, and mixtures thereof.

Further aspects of the invention include a column for chromatography which is packed with the any of forgoing described chromatographic media. A still further aspect of the invention is a process for separation of components of a solution comprising passing the solution through such a chromatography column and eluting components of the solution. Yet another further aspect of the invention is such a process wherein the solution is a solution containing biomolecules.

In yet another aspect of the invention, a method of making chromatographic media is provided, the method including reacting solid porous media particles containing an epoxy group or a haloalkyl group with an allylamine or polyallylamine derivative. In another aspect of the method of making, the polyallylamine is obtained by reacting an allylamine or polyallylamine having a molecular weight 25000 or less or by intermolecular polymerization through grafted allylamine.

In another aspect the chromatographic media may be made by: i) reacting solid porous media particles containing an epoxy group or haloalkyl group with an allylamine to form a polymer grafted with allylamine, and, ii) initiating intermolecular polymerization of said polymer grafted with allylamine. In another aspect, the intermolecular polymerization step is initiated by a radical initiator and excess allylamine, and in another aspect, radical initiator is selected from the group of azobisisobutyronitrile, acetyl peroxide or benzoyl peroxide.

The present invention provides that allylamine and its polymer such as polyallylamine having molecular weight of less than 25000 obtained directly or through intermolecular or intermolecular polymerization can be used as a primary ligand that can be modified to use as a weak anion, weak cation and hydrophobic media with distinct characteristics. The chromatographic media produced under this invention is completely different and unique in chemistry and performance than known art. The use of polyethyleneimine provides primary, secondary and tertiary amines while polyallyl amine provides only primary amines. The backbone is also different. The polyallylamine has linear alkyl chain with hanging amine groups. We have discovered that this feature obtained by method and composition of this invention provides different product with unique attributes. For example, the total nitrogen content of the modified polymer typically ranges from 1.0 to 3.5%. The produced weak anion exchangers can be directly used for proteins separation, or further modified to produce strong cation exchangers, strong anion exchangers or hydrophobic chromatographic media. This ligand can be immobilized by reacting the amino group of allylamine or polyallylamine with the epoxy groups in the polymer providing weak anion exchange chromatographic media.

In addition, the remaining amino groups could further react with different reagents to make chromatographic media with different functionality such as cation exchange, anion exchange or hydrophobic. Also, the allyl group in the allylamine provides possibilities for further modifications, such as intermolecular polymerization and functionalizes further to provide new ion-exchange or hydrophobic media.

### EXAMPLES

The present invention is further exemplified, but not limited, by the following representative examples, which are intended to illustrate the invention and are not to be construed as being limitations thereto.

### Example 1

### Preparation of Primary Ligand and Ion-Exchange Chromatographic Media with Polyallylamine

100 ml of 15 (w/w) % polyallylamine having molecular weight of 15,000 in aqueous solution and 300 ml deionized water were put in a 1 liter 3-neck flask equipped with a stirrer, condenser, nitrogen inlet, and temperature controller. 25 grams of polymethacrylate polymer with median particle size of 35 microns containing active epoxy group was added slowly into the reactor while stirring. The flask was then heated to 80° C. and allowed to react for 16 hours. The reaction product was washed with deionized water once, followed by washing four times with 1-methoxy-2-propanol. Elemental analysis: C, 58.3%, H, 7.3%, N, 1.1%.

The polymer from the above reaction was then transferred to a dry 1 liter 3-neck flask equipped with a stirrer, condenser, and nitrogen inlet and temperature controller. 400 ml of 1-methoxy-2-propanol and 14.5 g maleic anhydride were added to the flask under nitrogen. The flask was then heated to 60° C. and allowed to react for 3 hours. The product was washed with deionized water four times.

The maleated polymer from the above reaction was transferred back to the same reaction device, to which 400 ml of 0.01 M NaOH solution and 56 g sodium metabisulfite was added. The flask was then heated to 80° C. and allowed to react for 4 hours. The product was washed with deionized water four times. Elemental analysis: C, 55.8%; H, 7.2%; N, 1.0%; S, 1.0%.

### Example 2

### Separation Using Media of Example 1

The product from Example 1 was packed into a 100×7.75 mm ID column. The column was equilibrated with a 50 mM MES (2-(N-morpholino)ethanesulfonic acid) pH 5.6 buffer (Binding buffer). After equilibration, the column was injected with 100 ul of 2.0 mg/ml ovalbumin, 2.0 mg/ml rabbit IgG, 2.0 mg/ml lysozyme in binding buffer at 0.9 ml/min. The column was then eluted with a linear gradient of 0 to 100% 50 mM MES pH 5.6 buffer with 1.0 M NaCl (Elution buffer) in 26 min followed by 100% elution buffer for another 12 minutes. The result of the separation with the media of Example 1, as conducted according to Example 2, is shown in the graph of FIG. 1.

### Example 3

### Preparation of Primary Media Through Intermolecular Polymerization

10 g allylamine was dissolved in 400 ml 1-methoxy-2-propanol and the solution was transferred to a 1 liter 3-neck flask equipped with a stirrer, condenser, nitrogen inlet and temperature controller. 25 g polymethacrylate polymer with median particle size of 35 micron containing active epoxy group was added slowly into the reactor. The flask was then heated to 80° C. and allowed to react for 16 hours. The reaction product was washed with deionized water followed by four subsequent washes with alcohol.

The polymer grafted with allylamine from above reaction was then transferred to a dry 1 liter 3-neck flask equipped with a stirrer, condenser, and nitrogen inlet and temperature controller. To the flask, 400 ml ethanol, which was previously purged by nitrogen, was added. The flask was heated to 80° C. and added with 0.6 g AIBN, and then through syringe pump, 15 g allylamine was added at a flow rate of 0.2 ml/min and allowed to react for 6 hours. The product was washed with DI water followed by 1-methoxy-2-Propanol three times. Elemental analysis: C, 59.0%; H, 7.7 %; N, 3.1%.

The polymer from above reaction was then transferred to a dry 1 liter 3-neck flask equipped with a stirrer, condenser, and nitrogen inlet and temperature controller. To the flask, were added 400 ml 1-methoxy-2-propanol and 14.5 g maleic anhydride under nitrogen. Then the flask was heated to 80° C. and allowed to react for 3 h. The product was washed with DI water four times.

The maleated polymer from the above reaction was transferred back to the same reaction device. To which were added 400 ml 0.01 M NaOH solution and 56 g sodium metabisulfite. Then the flask was heated to 80° C. and allowed to react for 4 hours. The product was washed with deionized water four times. Elemental analysis: C, 54.5%; H, 7.8%; N, 3.0%; S, 2.0%.

### Example 4

### Separation Using Media from Example 3

The product from Example 3 was packed into a 100×7.75 mm ID column. The column was equilibrated with a 50 mM MES pH 5.6 buffer (Binding buffer). After equilibration, the column was injected with 100 ul of 2.0 mg/ml ovalbumin, 2.0 mg/ml rabbit IgG, 2.0 mg/ml lysozyme in binding buffer at 0.9 ml/min. Then the column was eluted with a linear gradient of 0 to 100% 50 mM MES pH 5.6 buffer with 1.0 M NaCl (Elution buffer) over 26 min followed by 100% elution buffer for another 12 minutes. The result of the separation with the media of Example 3, as conducted according to example 4, is shown in the graph of FIG. 2.

### Example 5

### Preparation of Primary Media with Allylamine

5 g allylamine was dissolved in 200 ml 1-methoxy-2-propanol, and the solution was transferred to a 1 liter 3-neck flask equipped with a stirrer, condenser, nitrogen inlet, and temperature controller. Under stirring, 12.5 g polymethacrylate polymer with median particle size of 35 micron containing active epoxy group was added slowly into the reactor. Then the flask was heated to 80° C. and allowed to react for 6 h. The reaction product was washed with deionized water followed by four subsequent washes with 1-methoxy-2-propanol. Elemental analysis: C, 58.9%; H, 7.3%; N, 2.5%.

The polymer from above reaction was then transferred to a dry 1 liter 3-neck flask equipped with a stirrer, condenser, and nitrogen inlet and temperature controller. To the flask, were added 200 ml 1-methoxy-2-propanol and 7.3 g maleic anhydride under nitrogen. Then the flask was heated to 80° C. and allowed to react for 3 hours. The product was washed with deionized water four times.

The maleated polymer from the above reaction was transferred back to the same reaction device, to which were added 200 ml 0.01 M NaOH solution and 28 g sodium metabisulfite. Then the flask was heated to 80° C. and allowed to react for 4 hours. The product was washed with deionized water four times. Elemental analysis: C, 52.4%; H, 6.8%; N, 2.3%; S, 2.0%.

### Example 6

### Separation with Media of Example 5

The product from Example 5 was packed into a 100×7.75 mm ID column. The column was equilibrated with a 50 mM MES pH 5.6 buffer (Binding buffer). After equilibration, the column was injected with 100 ul of 2.0 mg/ml ovalbumin, 2.0 mg/ml rabbit IgG, 2.0 mg/ml lysozyme in binding buffer at 0.9 ml/min. Then the column was eluted with a linear gradient of 0 to 100% 50 mM MES pH 5.6 buffer with 1.0 M NaCl (Elution buffer) over 26 min followed by 100% elution buffer for another 12 minutes. The result of the separation with the media of Example 5, as conducted according to Example 6, is shown in the graph of FIG. 3.

### Example 7

### Preparation of Primary Ligand and Ion-Exchange Chromatographic Media with Polyallylamine

100 ml 15 (w/w) % polyallylamine having molecular weight of 1000 in aqueous solution and 300 ml deionized water were put in a 1 liter 3-neck flask equipped with a stirrer, condenser, nitrogen inlet, and temperature controller. Under stirring, 25 g polymethacrylate polymer with median particle size of 35 micron containing active epoxy group was added slowly into the reactor. Then the flask was heated to 80° C. and allowed to react for 16 hours. The reaction product was washed with deionized water followed by four times with 1-methoxy-2-propanol. Elemental analysis: C, 58.3%; H, 7.9%; N, 1.7%.

The polymer from above reaction was then transferred to a dry 1 liter 3-neck flask equipped with a stirrer, condenser, and nitrogen inlet and temperature controller. To the flask, were added 400 ml 1-methoxy-2-propanol and 14.5 g maleic anhydride under nitrogen. Then the flask was heated to 80° C. and allowed to react for 3 hours. The product was washed with deionized water four times.

The maleated polymer from the above reaction was transferred back to the same reaction device, to which were added 400 ml 0.01 M NaOH solution and 56 g sodium metabisulfite. Then the flask was heated to 80° C. and allowed to react for 4 hours. The product was washed with deionized water four times. Elemental analysis: C, 54.3%; H, 7.3%; N, 1.5%; S, 1.2%.

### Example 8

### Separation Using the Media from Example 7

The product from Example 7 was packed into a 100×7.75 mm ID column. The column was equilibrated with a 50 mM MES pH 5.6 buffer (Binding buffer). After equilibration, the column was injected with 100 ul of 2.0 mg/ml ovalbumin, 2.0 mg/ml rabbit IgG, 2.0 mg/ml lysozyme in binding buffer at 0.9 ml/min. Then the column was eluted with a linear gradient of 0 to 100% 50 mM MES pH 5.6 buffer with 1.0 M NaCl (Elution buffer) in 26 minutes followed by 100% elution buffer for another 12 minutes. The result of the separation with the media of Example 7, as conducted according to Example 8, is shown in the graph of FIG. 4.

### Example 9

### Capacity Test using the Media of Example 7

The product from Example 7 was packed into a VersaTen (100×7.75 mm ID) column. The column was equilibrated with a 50 mM MES pH 5.0 buffer whose conductivity was adjusted to 3 mS/cm by NaCl (Binding buffer). To prepare the IgG sample solution, dissolve 360 mg human gamma globulins (Sigma PN G4386) in 180 ml binding buffer. After filtration and sonication, the sample solution was then injected into the column at a flow rate of 1.0 ml/min. After sample injection, the column was washed with binding buffer for 20 minutes; and the bonded IgG was eluted with 1.0 M NaCl in 50 mM MES pH 5.0 buffer at the same flow rate. The filtrate was monitored at UV 280 nm. The dynamic binding capacity at 10% breakthrough was calculated to be 66.5 mg/ml. Capacity test result for the media from Example 7 according to Example 9 is shown in FIG. 5.

### Example 10

### Capacity Test of Media from Example 1

The product from Example 1 was packed into a VersaTen (100×7.75 mm ID) column. The column was equilibrated with a 50 mM MES pH 5.0 buffer whose conductivity was adjusted to 3 mS/cm by NaCl (Binding buffer). To prepare the IgG sample solution, dissolve 360 mg human gamma globulins in 180 ml binding buffer. After filtration and sonication, the sample solution was then injected into the column at a flow rate of 1.0 ml/min. After sample injection, the column was washed with binding buffer for 20 minutes; and the bonded IgG was eluted with 1.0 M NaCl in 50 mM MES pH 5.0 buffer at the same flow rate. The filtrate was monitored at UV 280 nm. The dynamic binding capacity at 10% breakthrough was calculated to be 52.1 mg/ml. Capacity test result for the media from Example 1 according to Example 10 is shown in FIG. 6.

### Example 11

### Capacity Test of Media from Example 5

The product from Example 5 was packed into a VersaTen (100×7.75 mm ID) column. The column was equilibrated with a 50 mM MES pH 5.0 buffer whose conductivity was adjusted to 3 mS/cm by NaCl (Binding buffer). To prepare the IgG sample solution, dissolve 400 mg human gamma globulins in 200 ml binding buffer. After filtration and sonication, the sample solution was then injected into the column at a flow rate of 2.0 ml/min. After sample injection, the column was washed with binding buffer for 20 minutes; and the bonded IgG was eluted with 1.0 M NaCl in 50 mM MES pH 5.0 buffer at the same flow rate. The filtrate was monitored at UV 280 nm. The dynamic binding capacity at 10% breakthrough was calculated to be 54.3 mg/ml. Capacity test result for the media from Example 5 according to Example 11 is shown in FIG. 7.

### Example 12

### Capacity Test of Media from Example 3

The product from Example 3 was packed into a VersaTen (100×7.75 mm ID) column. The column was equilibrated with a 50 mM MES pH 5.0 buffer whose conductivity was adjusted to 3 mS/cm by NaCl (Binding buffer). To prepare the IgG sample solution, dissolve 400 mg human gamma globulins in 200 ml binding buffer. After filtration and sonication, the sample solution was then injected into the column at a flow rate of 2.0 ml/min. After sample injection, the column was washed with binding buffer for 20 minutes; and the bonded IgG was eluted with 1.0 M NaCl in 50 mM MES pH 5.0 buffer at the same flow rate. The filtrate was monitored at UV 280 nm. The dynamic binding capacity at 10% breakthrough was calculated to be 55.6 mg/ml. Capacity test result for the media from Example 3 according to Example 12 is shown in FIG. 8.

The Examples set forth above provide specific descriptions of actual working embodiments of the invention. And the results set forth in the Figures demonstrate the unique and highly effective separation characteristics using the present invention.

Thus while there have been described what are presently believed to be preferred embodiments of the invention, those skilled in the art will realize that changes and modifications may be made thereto without departing from the spirit of the invention, and it is intended to claim all such changes and modifications as fall within the true scope of the invention.

What is claimed:

1. Chromatographic media comprising porous media particles derivatized with allyamine or polyallylamine on the surface of the particles.

2. Chromatographic media according to claim 1 wherein the porous media particles comprise particles selected from the group consisting of epoxidized or haloalkylated silica, chitosan, cellulose, agarose, polystyrenes, polyacrylates or polymethacrylates, and polydivinylbenzenes.

3. Chromatographic media according to claim 2 wherein the porous media particles comprise epoxidized or haloalkylated polyacrylates or polymethacrylates polymers.

4. Chromatographic media according to claim 1 wherein the porous media particles derivatized with allylamine or polyallylamine on the surface of the particles are further functionalized by reaction of at least one other functionalization reagent with terminal amino groups of the allylamine or polyallylamine on the surface of the polymeric resin.

5. Chromatographic media according to claim 3 wherein the porous media particles derivatized with allylamine or polyallylamine on the surface of the particles are further functionalized by reaction of at least one other functionalization reagent with terminal amino groups of the allylamine or polyallylamine on the surface of the polymeric resin.

6. Chromatographic media according to claim 4 wherein the at least one other functionalization agent is selected from the group consisting of: acid anhydrides, sulfonation agents, alkyl chlorides, and alkyl chlorides containing quaternary ammonium functionality, and mixtures thereof.

7. Chromatographic media according to claim 6 wherein the functionalization reagent is selected from the group consisting of cyclic carboxylic anhydrides, unsaturated carboxylic anhydrides, bisulfites, alkyl chlorides, alkyl anhydrides, alkyl chlorides containing quaternary ammonium functionality and mixtures thereof.

8. Chromatographic media according to claim 7 wherein the at least one other functionalization reagent is selected from the group consisting of: glutaric anhydride, succinican hydrides, maleic anhydride, sodium meta-bisulfate, butyryl chloride, acetic anhydride, butyrican hydride, (3-chloro-2-hydroxypropyl)trimethylammonium chloride, and mixtures thereof.

9. Chromatographic media according to claim 1 wherein said porous media particles are derivatized with polyallylamine having a molecular weight less than 2500.

10. A column for chromatography which is packed with chromatographic media according to claim 1.

11. A column for chromatography which is packed with chromatographic media according to claim 3.

12. A column for chromatography which is packed with chromatographic media according to claim 5.

13. A column for chromatography which is packed with chromatographic media according to claim 8.

14. A process for separation of components of a solution comprising passing the solution through a chromatography column of claim 10 and eluting components of the solution.

15. A process for separation of components of a solution comprising passing the solution through a chromatography column of claim 11 and eluting components of the solution.

16. A process for separation of components of a solution comprising passing the solution through a chromatography column of claim 12 and eluting components of the solution.

17. A process for separation of components of a solution comprising passing the solution through a chromatography column of claim 13 and eluting components of the solution.

18. A process according to claim 14 wherein the solution is a solution containing biomolecules.

19. A method of making chromatographic media comprising reacting solid porous media particles containing an epoxy group or a haloalkyl group with an allylamine or polyallylamine derivative.

20. The method according to claim 19 wherein said polyallylamine is obtained by reacting an allylamine or polyallylamine having a molecular weight 25000 or less or by intermolecular polymerization through grafted allylamine.

21. A method of making chromatographic media comprising
i) reacting solid porous media particles containing an epoxy group or haloalkyl group with an allylamine to form a polymer grafted with allylamine, and
ii) initiating intermolecular polymerization of said polymer grafted with allylamine.

22. The method of claim 21 wherein said initiating intermolecular polymerization step is initiated by a radical initiator and excess allylamine.

23. The method of claim 22 wherein said radical initiator is selected from the group of azobisisobutyronitrile, acetyl peroxide or benzoyl peroxide.
